(19) United States
(12) Patent Application Publication
(10) Pub. No.: US 2011/0256412 A1
(43) Pub. Date: Oct. 20, 2011

(54) Aluminum nitride film and a substance coated with same

(75) Inventors: Koji Katoh, Annaka-shi (JP); Shoji Kano, Annaka-shi (JP)

(73) Assignee: SHIN-ETSU CHEMICAL CO., LTD., Tokyo (JP)

(21) Appl. No.: 13/064,768

(22) Filed: Apr. 14, 2011

(30) Foreign Application Priority Data
Apr. 15, 2010 (JP) 2010-094332

(51) Int. Cl. B32B 15/04; B05B 5/00; B32B 9/00; C01B 21/072

(52) U.S. Cl. 428/457; 423/412; 427/160; 428/698

(57) ABSTRACT

There are provided an aluminum nitride film and a substance, coated with such a film; the film is new in that it has a brightness or lightness L* of 60 or lower; preferably the film has a transmittance of 15% or lower for a visible and near infrared radiation having a wave length of 0.35-2.5 micrometers, the combined concentration of metallic elements as impurities but for Al is 50 ppm or smaller, and the film is heat-treated at a temperature of 1050 degrees centigrade or higher but lower than 1400 degrees centigrade, and the film is a product of CVD method; the substance coated with the film is preferably a ceramic material such as a nitride, an oxide, and a carbide or a metal having a low thermal expansion coefficient such as tungsten, molybdenum and tantalum.

The present non-provisional application claims priority under 35 U.S.C. §119(a) from Japanese Patent Application No. 2010-094332 filed on Apr. 15, 2010, the entire disclosure of which is hereby incorporated by reference.

### TECHNICAL FIELD

The invention hereof is related to an aluminum nitride film which forms a coating layer for substances used in semiconductor manufacturing process and other similar processes.

### BACKGROUND OF INVENTION

A dry process in the semiconductor manufacturing scene abounds in kinds and amounts of erosive halogen gases such as highly reactive fluorine gas and chlorine gas as gases for etching and cleaning. The substances that are exposed to such erosive gases are required to be highly corrosion resistive.

In the past, it was so designed that the substances that are touched by the erosive gases except for the substances that are themselves processed are generally made of stainless steel, aluminum or the like; however, in recent years, it has been confirmed that alumina and aluminum nitride are substances that strongly resist erosive gases, especially halogen gases.

An aluminum nitride film itself is apt to turn into some yellow whitish color in general. However, substances that are used as a susceptor, cramp ring, or a heater are desired to be black in color. And this is because a black substance is more productive of radiant heat than a white substance and furthermore heating properties are better too in the case of a black substance. Also, if such kind of substances as these were yellow whitish in the color of their surfaces, a problem arose that an uneven color distribution, due to dust or the like, is apt to occur over the surfaces of the substances and counter-measures for this problem are called for.

It has been known to manufacture a black sintered aluminum nitride through the steps of adding an appropriate transition metal element(s) to a green material powder and sintering it (see Publications-in-Patent 1-3).

Publication-in-patent 1 discloses a sintered aluminum nitride ceramic in which occurrences of stains and uneven color distribution are restricted through an addition of Er (erbium) in an amount of 5 weight % or more, in terms of metal-to-metal ratio, to aluminum nitride, to thereby trap, as grain boundary crystals, the oxygen solid-solved in the An crystals and the oxygen residing on the surface of the grains.

Also, Publication-in-patent 2 discloses a ceramic base plate which exhibits infrared ray transmittance of 0 or no more than 10%, which is achieved by adding a predetermined amount of carbon into a ceramic base plate, through the steps of forming a green body by shaping a mixture of ceramic powder and resin under pressure, subjecting this green body to degreasing and then sintering, to thereby lower the crystallinity of the carbon.

Further, Publication-in-patent 3 discloses that a fine-grained sintered substance is obtained through an addition of aluminum oxide to a hard-to-sinter aluminum nitride, that by virtue of the fact that an AlON phase having lattice defects is created during the sintering the sintered body is colored in black and thereby the problem of uneven distribution of color in An is solved, and that the mechanical properties of the sintered body are improved thanks to the strengthening of the dispersion of the An particles and AlON particles.

However, the black sintered aluminum nitride according to Publication-in-patent 1 contains Er as an additive so that it releases Er originated impurity during the semiconductor manufacturing process to adversely affect the devices.

The sintered material according to Publication-in-patent 2 contains carbon so that the carbon tends to segregate in the grain boundaries to thereby render the material hard-to-sinter, and thus to lower its rupture strength.

The substance according to Publication-in-patent 3 is deemed to have high utility in that it contains no additives but aluminum oxide, which by itself, however, does not suffice to prevent rising of the liquid phase reaction temperature during sintering and renders it necessary to set a higher temperature for the thermal process due to the high viscosity of the aluminum oxide liquid phase. Also, a further problem exists in that the substance can be produced only in limited kinds of methods such as hot pressing due to its hard-to-pulverize characteristics.

On one hand, the inventors hereof have developed a technology for coating semiconductor devices such as susceptors, cramp rings, and heaters with a highly corrosion-resistant aluminum nitride film by a CVD method (see Publication-in-patent 4).

On the other hand, the aluminum nitride film produced by the CVD method can be produced in a thermal process at a temperature half as high as that in the case of the sintered bodies, which temperature is 1600 degrees centigrade or higher. Furthermore, the metallic impurities exist in the film in far lower concentrations compared with the case of the aluminum sintered body.

However, the aluminum nitride film produced by CVD method exhibits yellowish white color so that it is inferior in terms of heating property with regard to radiation, and is apt to exhibit uneven color distribution over its surface originating from contamination.

### LIST OF PRIOR ART PUBLICATIONS

### Publications-in-Patent

[Publication-in-patent 1] Japanese Published Patent Application H06-116039
[Publication-in-patent 2] Japanese Patent No. 3618640
[Publication-in-patent 3] Japanese Patent No. 4223043
[Publication-in-patent 4] Japanese Published Patent Application 2009-078193

### SUMMARY OF THE INVENTION

### Problems the Invention Seeks to Solve

In view of the circumstances described hereinabove, the present invention seeks to provide an aluminum nitride film that scarcely exhibits uneven color distribution and is scarcely eroded by halogen gases, and at the same time provides an aluminum nitride substance wearing such a film

### Means to Solve the Problem

The aluminum nitride film of the present invention is characteristic of having a brightness or lightness L* of 60 or lower in terms of the standard according to JIS Z8729. It is preferable that the film has a transmittance of 15% or lower for a visible and near infrared radiation having a wave length of 0.35-2.5 micrometers, that the combined concentration of metallic elements as impurities but for Al is 50 ppm or smaller, that the film is heat-treated at a temperature of 1050 degrees centigrade or higher but lower than 1400 degrees centigrade, and that the film is a product of CVD (chemical vapor deposition) method.

Furthermore, the substance according to the present invention is characteristic of being made of a base material which is a ceramic material such as a nitride, an oxide, and a carbide or a metal having a low thermal expansion coefficient such as tungsten, molybdenum and tantalum, and that such base material is coated with an aluminum nitride film as defined in any of the claims 1 through 5.

### Effects of the Invention

By coating the substances with the aluminum nitride film of the present invention, it is possible to obtain devices for semiconductor manufacturing process which devices are capable of being used in an environment of a corrosive halogen gas, are excellent in heating properties, and are virtually free of uneven color distribution in their surfaces.

### BRIEF DESCRIPTION OF DRAWINGS

FIG. 1 is a drawing showing a ceramics substance coated with the aluminum nitride film of the present invention.

FIG. 2 is a chart showing the variations in lightness L* before and after the heat treatment.

FIG. 3 is a chart showing the variations in transmittance before and after the heat treatment.

### EMBODIMENTS TO PRACTICE THE INVENTION

The present inventors went through extensive and earnest studies and came to find that by subjecting a yellow whitish aluminum nitride to a heat treatment the nitride blackens, and thus realized that it is possible to obtain an aluminum nitride substance which exhibits reduced uneven color distribution in its surface and has improved properties with respect to radiant heating, and thus possessed the present invention.

Now, we will explain about the aluminum nitride film of the present invention.

The aluminum nitride film according to the present invention has a lightness L* of 60 or lower in terms of the standard according to JIS Z8729 (claim 1), so that it is black in color, and thus it is hard for contaminants to develop uneven color distribution across the surface. Also, blackish films such as this are characteristic in that they transmit scarce infrared rays so that their heating properties are high. It would further more preferable if the lightness L* of the film is 40 or less.

If the film has a transmittance of 15% or lower for a visible and near infrared radiation having a wave length of 0.35-2.5 micrometers (claim 2), the peak wave length of the infrared radiation as calculated in accordance with Wien's displacement law becomes about 2.5 micrometers at 800 degrees centigrade so that the film would have excellent heating properties with regard to heating by radiation.

When the combined concentration of the metallic elements existing as impurities not including Al is 50 ppm or smaller (claim 3), the film does not adversely affect the devices during semiconductor manufacturing process, unlike the conventional sintered aluminum nitride substances of which the alkaline-earth metals, rare earth metals and the like that are contained as sintering additives (aids) act as impurities to ill-affect the devices. It is more preferred if the concentration of the non-Al metallic elements is 30 ppm or smaller.

A high-purity film that is preferably suitable for this invention, satisfying the above-mentioned purity levels, may be such aluminum nitride films that are manufactured by CVD (Chemical Vapor Deposition) method, or more assuredly those manufactured by MOCVD (Metal Organic Chemical Vapor Deposition) method or those manufactured by HVPE (Halide Vapor Phase Epitaxy) method.

The mechanism for the blackening phenomenon has not been known yet, but the aluminum nitride films that are manufactured by MOCVD method or HVPE method are more amorphous compared with sintered substances, so that when such films are subjected to a heat treatment at a temperature as high as 1050 to 1400 degrees centigrade, more lattice defects are thought to occur in the structure of the aluminum nitride. By virtue of the existence of such lattice defects, it is suspected that the light absorption band widens and hence the blackening takes place.

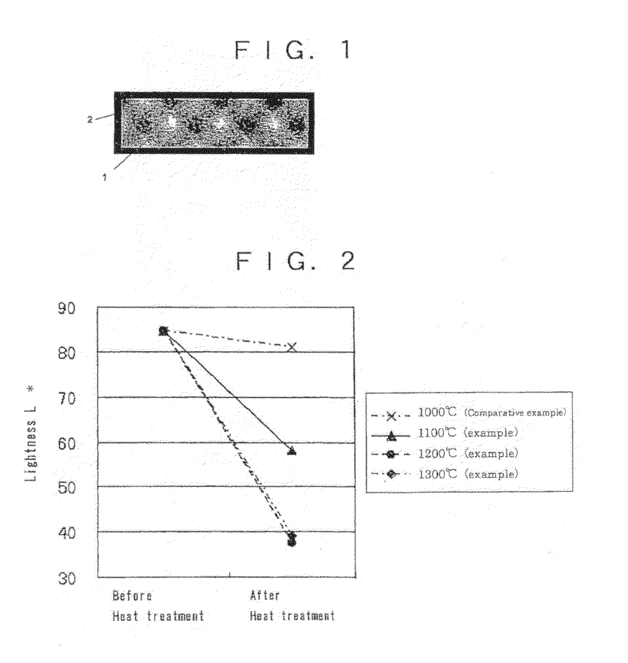

The substance coated with the aluminum nitride film as obtained by the present invention is, as shown in FIG. 1, constituted by a base material 1 and an aluminum nitride film 2, the surface of the former 1 being entirely covered with the latter 2.

It is suggested that the base material may be made of a ceramic material such as a nitride, an oxide, and a carbide or a metal having a low thermal expansion coefficient such as tungsten, molybdenum and tantalum.

The aluminum nitride film of the present invention preferably has a lightness of 60 or lower in terms of L* according to JIS Z8729, and has a transmittance of 15% or lower for a visible near infrared radiation having a wave length of 0.35-2.5 micrometers, and has metallic impurities excluding Al in an amount of 50 ppm or smaller; in order to secure these characteristics, it is advised that the film after formation be subjected to a heat treatment at a temperature of 11050 degrees centigrade or higher but lower than 1400 degrees centigrade.

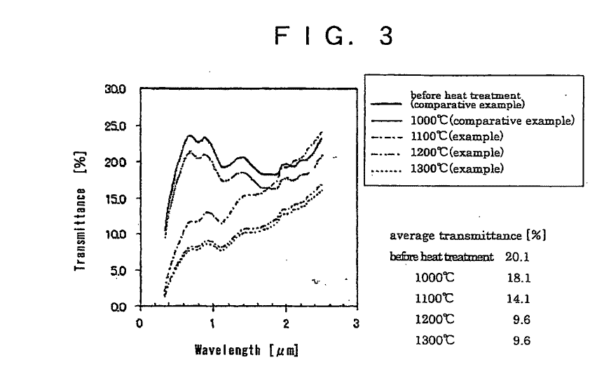

The variations that the aluminum nitride film underwent in terms of the composition of the metallic impurities, lightness, and optical transmittance caused by the heat treatment, that was conducted after the film was formed, are shown in Table 1, FIG. 2 and FIG. 3

The sample pieces were prepared by depositing a 100-micrometer thick aluminum nitride film on the entire surface of aluminum nitride base plates measuring 50 mm×50 mm×1 mm by MOCVD method, wherein trimethyl aluminum and ammonium were used as the raw materials to react with each other at 950 degrees centigrade in a vacuum furnace. Thereafter, the sample pieces were moved to a heat-treatment furnace and were subjected to a heat treatment at 1000-1300 degrees centigrade in Ar gas.

The concentrations of the impurity metallic elements were measured by means of ICP-MSElan DRC-II manufactured by Perkin-Elmer Inc.

The lightness and the chromaticity (in terms of L*, a*, b* of color space (CIELAB)) of the samples were measured by a chromatic meter CR-200 manufactured by Minolta Inc.

Then, the transmittance and the reflectivity of the samples before and after the heat treatment were measured in the cases taken from the wave length realm of 0.35-2.5 micrometers with a spectro-photometer UV-3101PC manufactured by SHIMADZU CORPORATION. Defining the totality of the transmittance, reflection and absorption of light as 1, the differential amounts in transmittance and reflection was used to calculate the absorptance (radiation ratio).

The results of the measurements are shown in Table 1, FIG. 2 and FIG. 3, respectively.

TABLE 1

| | | | | | | | | | | | | | | | | other |
|---|---|---|---|---|---|---|---|---|---|---|---|---|---|---|---|---|
| | | | | | | | | | | | | | | | | metallic |
| | Si | Fe | Cr | Ni | Mn | Zn | Co | Cu | Mg | Na | Ca | K | Ti | Y | V | elements |
| before | 48 | 0.8 | 0.9 | 1.0 | <0.5 | 0.6 | <0.5 | 0.8 | <0.5 | <0.5 | 2.2 | <0.5 | <0.5 | <0.5 | <0.5 | <0.5 |
| heat | | | | | | | | | | | | | | | | |
| treatment | | | | | | | | | | | | | | | | |
| after | 47 | 0.9 | 1.0 | 0.9 | <0.5 | 0.8 | <0.5 | 0.9 | <0.5 | <0.5 | 2.4 | <0.5 | <0.5 | <0.5 | <0.5 | <0.5 |
| 1000° C. | | | | | | | | | | | | | | | | |
| heat | | | | | | | | | | | | | | | | |
| treatment | | | | | | | | | | | | | | | | |
| after | 30 | 1.0 | 0.7 | 1.2 | <0.5 | 0.7 | <0.5 | 0.7 | <0.5 | <0.5 | 2.1 | <0.5 | <0.5 | <0.5 | <0.5 | <0.5 |
| 1100° C. | | | | | | | | | | | | | | | | |
| heat | | | | | | | | | | | | | | | | |
| treatment | | | | | | | | | | | | | | | | |
| after | 25 | 0.7 | 1.0 | 0.8 | <0.5 | 0.7 | <0.5 | 0.7 | <0.5 | <0.5 | 2.2 | <0.5 | <0.5 | <0.5 | <0.5 | <0.5 |
| 1200° C. | | | | | | | | | | | | | | | | |
| heat | | | | | | | | | | | | | | | | |
| treatment | | | | | | | | | | | | | | | | |
| after | 21 | 1.1 | 0.8 | 0.9 | <0.5 | 0.6 | <0.5 | 0.7 | <0.5 | <0.5 | 2.1 | <0.5 | <0.5 | <0.5 | <0.5 | <0.5 |
| 1300° C. | | | | | | | | | | | | | | | | |
| heat | | | | | | | | | | | | | | | | |
| treatment | | | | | | | | | | | | | | | | |

Unit in ppm

Table 1 shows the concentrations of the impurity metallic elements before and after each heat treatment at the respective temperatures, the more typical metals being singled out. There were found no substantial changes in the impurity concentrations between before and after the heat treatments, so that it was indicated that the changes, in the lightness and the transmittance were not caused by the metallic impurities. FIG. 2 shows the variations of the lightness before and after the heat treatments with respect to the temperatures. FIG. 3 is a graph in which the transmittance values are plotted against the wave length values to show the transmittance variations before and after the heat treatment with respect to the heat treatment temperatures, the abscissa being the wave length and the ordinate being the transmittance.

### EXAMPLES

Now, we will describe examples and comparative examples, but the scope of the present invention is not to be contained by those descriptions.

### Example 1

A 100-micrometer thick film of aluminum nitride was formed over the surface of an aluminum nitride base piece measuring 50 mm×50 mm×t1 mm at a temperature of 950 degrees centigrade in a vacuum furnace by means of MOCVD method utilizing trimethyl aluminum and ammonia as the raw materials. Thereafter, the piece was brought into a heat treatment furnace and was subjected to a heat treatment of 1100 degrees centigrade in an argon atmosphere for one hour, whereby an aluminum nitride film was completed.

The lightness and the chromaticity (in terms of L*, a*, b* of color space (CIELAB)) of the sample piece before and after the heat treatment were measured using the chromatic meter CR-200 manufactured by Minolta Inc.

The measurement results showed that although the chromaticity a*, b* did not undergo any substantial variation during the heat treatment, the lightness L* was observed to have dropped from 84.7 to 58.2.

Next, the transmittance and the reflectivity of the sample piece before and after the heat treatment were measured in the cases taken from the wave length realm of 0.35-2.5 micrometers with the spectro-photometer UV-3101PC manufactured by SHIMADZU CORPORATION.

It was observed that the average value of the transmittance declined from 20.1 to 14.6 percents as a result of the heat treatment, in the cases taken from the wave length realm of 0.35-2.5 micrometers.

The concentrations of the metallic elements as impurities were measured by means of ICP-MSElan DRC-II manufactured by Perkin-Elmer Inc.

The ratio of each impurity element was smaller than 50 ppm before and after the heat treatment, so that this invented aluminum nitride film passes as a high purity material.

### Example 2

A 100-micrometer thick film of aluminum nitride was formed over the surface of an aluminum nitride base piece measuring 50 mm×50 mm×t1 mm at a temperature of 950 degrees centigrade in a vacuum furnace by means of MOCVD method utilizing trimethyl aluminum and ammonia as the raw materials. Thereafter, the piece was brought into a heat treatment furnace and was subjected to a heat treatment of 1200 degrees centigrade in an argon atmosphere for one hour, whereby an aluminum nitride film was completed.

The lightness and the chromaticity (in terms of L*, a*, b* of color space (CIELAB)) of the sample piece before and after the heat treatment were measured using the chromatic meter CR-200 manufactured by Minolta Inc.

The measurement results showed that although the chromaticity a*, b* did not undergo any substantial variation during the heat treatment, the lightness L* was observed to have dropped from 84.7 to as low as 37.5.

Next, the transmittance and the reflectivity of the sample piece before and after the heat treatment were measured in the cases taken from the wave length realm of 0.35-2.5 micrometers with the spectro-photometer UV-3101PC manufactured by SHIMADZU CORPORATION.

It was observed that the average value of the transmittance declined from 20.1 to 9.6 percents as a result of the heat treatment, in the cases taken from the wave length realm of 0.35-2.5 micrometers.

The concentrations of the metallic elements as impurities were measured by means of ICP-MSElan DRC-II manufactured by Perkin-Elmer Inc.

The ratio of each impurity element was smaller than 50 ppm before and after the heat treatment, so that this aluminum nitride film passes as a high purity material.

### Example 3

A 100-micrometer thick film of aluminum nitride was formed over the surface of an aluminum nitride base piece measuring 50 mm×50 mm×t1 mm at a temperature of 950 degrees centigrade in a vacuum furnace by means of MOCVD method utilizing trimethyl aluminum and ammonia as the raw materials. Thereafter, the piece was brought into a heat treatment furnace and was subjected to a heat treatment of 1300 degrees centigrade in an argon atmosphere for one hour, whereby an aluminum nitride film was completed.

The lightness and the chromaticity (in terms of L*, a*, b* of color space (CIELAB)) of the sample piece before and after the heat treatment were measured using the chromatic meter CR-200 manufactured by Minolta Inc.

The measurement results showed that although the chromaticity a*, b* did not undergo any substantial variation during the heat treatment, the lightness L* was observed to have dropped from 84.7 to as low as 39.1

Next, the transmittance and the reflectivity of the sample piece before and after the heat treatment were measured in the cases taken from the wave length realm of 0.35-2.5 micrometers with the spectro-photometer UV-3101PC manufactured by SHIMADZU CORPORATION.

It was observed that the average value of the transmittance declined from 20.1 to 9.6 percents as a result of the heat treatment, in the cases taken from the wave length realm of 0.35-2.5 micrometers.

The concentrations of the metallic elements as impurities were measured by means of ICP-MSElan DRC-II manufactured by Perkin-Elmer Inc.

The ratio of each impurity element was smaller than 50 ppm before and after the heat treatment, so that this aluminum nitride film passes as a high purity material.

### Comparative Example 1

A 100-micrometer thick film of aluminum nitride was formed over the surfaces of a couple of aluminum nitride base pieces measuring 50 mm×50 mm×t1 mm at a temperature of 950 degrees centigrade in a vacuum furnace by means of MOCVD method utilizing trimethyl aluminum and ammonia as the raw materials. Thereafter, one of the pieces was subjected to a heat treatment of 1000 degrees centigrade in an inert gas atmosphere of argon for one hour in the vacuum furnace, and another piece was similarly heat-treated at 1400 degrees centigrade.

The aluminum nitride film that was heat-treated at 1000 degrees centigrade remained white in color and its lightness L* and transmittance changed only slightly from 84.7 to 81.0 and from 20.1 to 18.1, respectively. The aluminum nitride film that was heat-treated at 1400 degrees centigrade was found to have sublimated entirely in the vacuum furnace.

Similar experiments were conducted wherein the base material of aluminum nitride was replaced by ones made of other materials such as alumina, silicon carbide, and tungsten, and the resulting aluminum nitride films as they were subjected to the similar heat-treatments underwent similar phenomena as the aluminum nitride film of Comparative Example 1.

As described above, the aluminum nitride film of the present invention, which is prepared by CVD method, turns black as its lightness L* drops to a value of 60 or smaller during the subsequent high temperature heat treatment, and at the same time the transmittance against the wave length realm of 0.35-2.5 micrometers becomes 0.15 or lower, so that the invented aluminum nitride film is freed from the uneven color distribution and has a good thermal property with regard to radiation. Furthermore, the aluminum nitride film prepared by CVD method contains impurity metallic elements except for aluminum in an amount no more than 50 ppm respectively, and no more than 100 ppm collectively, so that it is ridden of the concern that the devices are ill-affected in the course of semiconductor manufacturing process.

### POSSIBILITY FOR INDUSTRIAL APPLICATION

The aluminum nitride film, according to the present invention, is useful when it is laid over a substance, for such a substance can make an excellent susceptor, cramp ring, heater, etc. in a semiconductor manufacturing apparatus, for the reason that the invented aluminum nitride film exhibits high amount of heat radiation and good thermal characteristics. Therefore, there are expected improved throughput and energy saving in the semiconductor related manufacturing processes.

### EXPLANATION OF REFERENCE NUMERALS

1. base material
2. aluminum nitride film

What is claimed is:

1. An aluminum nitride film characterized in having a lightness L* of 60 or lower as defined in JIS Z8729.

2. An aluminum nitride film as claimed in claim 1 characterized in having a transmittance of 15% or lower for a visible and near infrared radiation having a wave length of 0.35-2.5 micrometers.

3. An aluminum nitride film as claimed in claim 2 characterized in that a combined concentration of metallic impurities but for aluminum is 50 parts per million or smaller.

4. A method for manufacturing an aluminum nitride film having a lightness L* of 60 or lower as defined in JIS Z8729, a transmittance of 15% or lower for a visible and near infrared radiation having a wave length of 0.35-2.5 micrometers, and metallic impurities but for aluminum in an amount of 50 parts per million or smaller, comprising steps of: (i) forming an aluminum nitride film on a base material of a low thermal expansion coefficient by chemical vapor deposition method, and (ii) heat-treating said film at a temperature of 1050 degrees centigrade or higher but lower than 1400 degrees centigrade.

5. A method for manufacturing an aluminum nitride film as claimed in claim 4 wherein said base material is made of a ceramic material selected from a nitride, an oxide, and a carbide.

6. A method for manufacturing an aluminum nitride film as claimed in claim 4 wherein said base material is made of a metal selected from tungsten, molybdenum and tantalum.

7. A substance consisting of a base material of a low thermal expansion coefficient and an aluminum nitride film as defined in claim 3.

8. A substance as claimed in claim 7 wherein said base material is made of a ceramic material selected from a nitride, an oxide, and a carbide.

9. A substance as claimed in claim 7 wherein said base material is made of a metal selected from tungsten, molybdenum and tantalum.
